(19) United States
(12) Patent Application Publication
(10) Pub. No.: US 2004/0213185 A1
(43) Pub. Date: Oct. 28, 2004

(54) System and method of controlling forward link transmit power

(76) Inventors: Seong-Jun Oh, San Diego, CA (US); Young C. Yoon, San Diego, CA (US)

Correspondence Address: COATS & BENNETT, PLLC, P O BOX 5, RALEIGH, NC, 27602, US

(21) Appl. No.: 10/423,535

(22) Filed: Apr. 25, 2003

(51) Int. Cl. H04B 7/216

(52) U.S. Cl. 370/335; 370/342; 455/522

(57) ABSTRACT

An apparatus and method reduce transmit power fluctuations in a wireless communication network. In one embodiment, a base station transmitter transmits communication signals as needed, e.g., overhead channel signals, dedicated traffic channel signals, etc., at whatever combined power level is required for such signals. Where the combined transmit power for the communication signals falls below a target level, the transmitter transmits additional power via one or more null signals, e.g., signals not intended for use by any receiving station, at whatever transmit power is needed to make up the difference and thereby maintain the total transmit power substantially at the target level. For example, the transmitter may transmit a shared packet data channel signal with either null data or user data, depending on whether user data is available for any station sharing the channel, and thereby avoid power fluctuations that would arise from intermittent transmission of the shared signal.

### BACKGROUND OF THE INVENTION

The present invention generally relates to wireless communication networks and particularly relates to reducing transmit power fluctuations at, for example, network base stations.

In a typical wireless communication network, e.g., a cellular radio network, base stations transmit signals to and receive signals from pluralities of mobile stations. A given base station provides radio coverage for one or more defined service areas, with such service areas commonly denoted as “cells” or “sectors.” For convenience, the terms cell and sector are used interchangeably herein unless otherwise noted.

Mobile stations within a particular sector typically are served by that sector's base station, although communication networks employing Code Division Multiple Access (CDMA) techniques often provide for “soft handoff,” wherein more than one base station communicates with the mobile station. Regardless, power control represents a key feature enabling effective capacity utilization.

Many types of CDMA networks, e.g., IS-95B, IS-2000, WCDMA, etc., use closed loop power control on at least some forward and reverse radio links to ensure that the network base stations and mobile stations generally transmit at power levels no higher than needed to meet desired signal quality targets. Thus, a supporting base station transmits power control commands, often in the form of streaming control bits, commanding a particular mobile station to increase or decrease its transmit power as needed to maintain targeted received signal quality at the base station. Likewise, the mobile station transmits power control commands at a given rate back to the base station, commanding the base station to increase or decrease its transmit power as needed to maintain targeted received signal quality at the mobile station.

With the above approach, less power is allocated to the radio links associated with mobile stations experiencing good radio conditions and more power is allocated to radio links associated with mobile stations experiencing poor radio conditions. Of course wireless networks are, as a whole, extremely dynamic systems and transmit powers often vary widely over time as conditions change and as mobile stations are added to and dropped from the network. Essentially, then, the typical radio base station operates with ever changing total transmit power and the instantaneous total forward transmit power (i.e., its aggregate transmit power output on all forward radio links) may vary widely between minimum and maximum power levels.

Further, developing standards, such as Revision C of the IS-2000 standard (also referred to as “Release C”), or the latest WCDMA standards, promise even greater variations in base station total transmit power. For example, use of shared, high-speed packet data channels will result in base stations operating with potentially significant transmit power fluctuations. With such shared channels, a base station can transmit a high-bandwidth and/or high-powered radio channel signal that is shared by one or more mobile stations but that serves only one mobile station at any given instant in time. By scheduling transmissions to individual mobile stations, all mobile stations sharing the channel receive data at scheduled intervals, subject to radio condition limitations. Various scheduling algorithms are known, such as proportional fair scheduling, maximum throughput scheduling, etc.

Characteristically, these shared channels operate in “on/off” states, meaning that a shared packet data channel signal is not transmitted unless there is available data for one or more mobile stations. In other words, the shared channel signal is not transmitted unless there is user data to transmit.

If there is data to transmit, the base station typically allocates its remaining transmit resources (e.g., remaining channelization codes), including its remaining or “leftover” transmit power, e.g., whatever power is not already allocated to other forward radio links, to the shared channel signal. Thus, beginning or ending data transmission on a shared channel causes potentially large step-like increases or decreases in base station transmit power. As the shared channel alternates between active and inactive states, the total forward power from the base station undergoes significant and rapid power fluctuations.

The fluctuations associated with the use of shared channels and, more generally, with dynamically changing radio conditions on the aggregate set of radio links supported by a given base station, result in fluctuating levels of inner-cell and outer-cell interference.

Rapidly changing interference levels complicate not only power control but also rate control. For clarification, power control is needed for dedicated channels (e.g. voice traffic channels or dedicated data traffic channels). On the other hand, rate control is needed for the high-speed shared channels. Power control compensates fast fading by sending more power when fading attenuates the signal and by reducing transmit power under good fading conditions. In contrast, rate control compensates fast fading by transmitting at lower data rates (lower modulation order and higher coding rates for more protection) under bad fading conditions and by increasing the data rate (higher modulation order and lower coding rates for less protection) under good fading conditions.

In addition to the interference fluctuations and resultant power/rate control complications that arise from rapidly changing base station transmit powers, the requirements for supporting such rapid power changes complicates base station design. That is, the RF transmitters must be designed to operate over wide power ranges and must support rapid and potentially large changes in operating power.

### SUMMARY OF THE INVENTION

The present invention comprises a method and apparatus to reduce power fluctuations in a wireless communication network. In an exemplary embodiment, a network transmitter transmits communication signals as needed to support communication with one or more mobile stations, and transmits one or more null signals, e.g., transmitted signals not intended for use by any receiving station, as needed to reduce fluctuations in a total transmit power of the transmitter. A null signal power control circuit may be associated or included with the transmitter to control null signal transmit power.

By reducing power fluctuations, variations in inner-cell and outer-cell interference may be reduced, particularly where the present invention is practiced at a plurality of neighboring network transmitters (e.g., base stations). In addition to reducing interference fluctuations, reducing transmit power fluctuations may simplify the design and operation of radio frequency (RF) transmitters used in network base stations.

In exemplary detail, a radio base station transmitter transmits communication signals as needed with a varying combined communication signal power to support communication with one or more mobile stations, and transmits one or more null signals as needed with a varying combined null signal power to reduce fluctuations in a total transmit power of the radio base station. In support of this function, a target power level may be defined for the base station's total transmit power, the total transmit power being defined as the communication signal power plus the null signal power.

In operation, the base station varies the communication signal power as needed to support communications, and inversely varies the null signal power to maintain the total transmit power substantially at the target level. Thus, as the communication signal power increases toward the target level, less null signal power is used, and vice versa. If the target level is less than the maximum transmit power, the communication signal power may be increased above the target level as needed up to the maximum level, in which case the null signal power is set to zero or some minimum value.

Where the base station transmits a shared packet data channel signal as one of its transmitted communication signals, an exemplary embodiment of the present invention transmits the shared channel signal on an uninterrupted basis by including user data in the shared packet data channel signal if user data is available for any of one or more mobile stations sharing the shared packet data channel signal, and including null data in the shared packet data channel signal if no user data is available. Such operation is in contrast to the conventional on/off shared channel approach, which causes substantially large transmit power fluctuations by activating and deactivating shared packet data channel signals depending on whether there is any actual user data to transmit. Examples of such channels include, but are not limited to, Forward Packet Data Channels (F-PDCH) in networks based on Revision C of the IS-2000 standards, and High Speed Packet Data Access (HSPDA) channels in networks based on the WCDMA standards.

In support of the present invention's power control, an exemplary radio base station, such as an IS-2000 or WCDMA base station, comprises one or more radio frequency (RF) transmitter circuits used to transmit the various communication and null signals as needed, and further comprises one or more control circuits to control transmission of communication signals as needed to support communications, and to control transmission of one or more null signals as needed to reduce fluctuations in the base station's total transmit power. Thus, the base station may include, or otherwise be associated with, a null signal power controller, which may be implemented in hardware, software, or some combination thereof, to control whether and at what powers the one or more null signals are transmitted by the base station.

Those skilled in the art should understand that the term “base station” is given broad construction herein, and is meant to encompass Radio Base Stations (RBSs) or Base Transceiver Stations (BTSs) alone or with Base Station Controllers (BSCs). Thus, the control logic for management of a base station's total transmit power to reduce power fluctuations in accordance with the present invention may be implemented within individual RBSs, or may be implemented within the processing circuits of a BSC that controls one or more RBSs. Thus, a BSC may control the total transmit power of several RBSs on an individual or collective basis as needed or desired.

### BRIEF DESCRIPTION OF THE DRAWINGS

FIG. 1 is a diagram of an exemplary embodiment of the present invention.

FIG. 2 is a diagram of exemplary total transmit power control using null signals.

FIG. 3 is another diagram of exemplary total transmit power control using null signals.

FIG. 4 is a diagram of an exemplary wireless communication network.

FIG. 5 is a diagram of an exemplary radio base station.

FIG. 6 is a diagram of exemplary radio base stations in a sectorized cell arrangement.

### DETAILED DESCRIPTION OF THE INVENTION

At the outset, it should be understood that the present invention broadly operates to reduce power fluctuations from a wireless transmitter, such as a RF communication transmitter. Communication transmitters typically transmit one or more communication signals at varying powers because of changing radio conditions, changing signal quality requirements, and because of changing load and demand. With one or more exemplary embodiments of the present invention, a power controller allocates a variable portion of a communication transmitter's available transmit power to one or more null signals that are transmitted as needed to reduce fluctuations in the overall total transmit power of the communication transmitter. As such, it should be understood that the present invention has direct applicability to a broad range of wireless communication networks, including, but not limited to, those networks based on IS-95, IS-2000, WCDMA, or other developing wireless communication standards.

Further, it should be understood that an exemplary embodiment of the present invention includes a transmitter and a controller to control the transmit power allocated to one or more “null” signals transmitted by the transmitter. The controller, whether implemented in hardware, software, or some combination thereof, may or may not be co-located or integrated with the transmitter. Thus, the present invention adapts to essentially any wireless network architecture and does not rely on any particular arrangement of network entities, such as base station controllers, transmitters, etc.

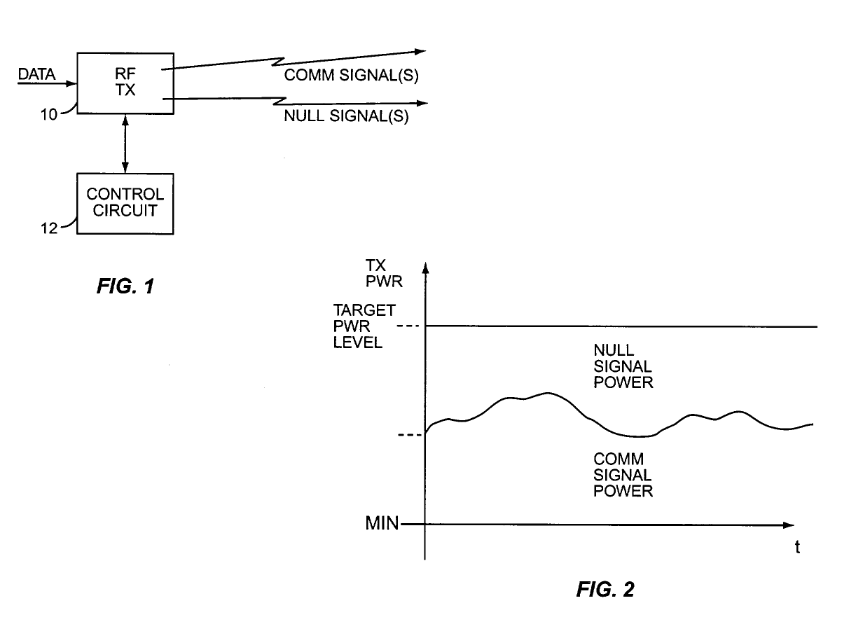

With the above framework in mind, FIG. 1 illustrates an exemplary embodiment of the present invention comprising a transmitter 10 and a null signal controller 12. Transmitter 10 transmits one or more communication signals as needed to support communication with one or more remote stations, and transmits one or more null signals as needed to reduce fluctuations in the overall transmit power of transmitter 10. The null signal controller 12 controls the transmission of null signals from transmitter 10 and, in one or more exemplary embodiments, it works generally to reduce fluctuations in the total transmit power of transmitter 10.

For reference herein, the transmitter 10 and controller 12 together comprise a “network node,” which may be defined as a functional or logical grouping of one or more network elements (at one or more sites) that provides defined network related functions. The network node thus defined may include additional network entities or other control elements as needed or desired and, as used herein with respect to null signal transmission, the term network node includes at least the transmitter 10 and power control circuit 12 irrespective of whether these two entities are physically co-located.

Further, those skilled in the art will understand that transmitter 10 itself may comprise a collection of individually controllable transmitting elements such that a plurality of communication signals may be independently transmitted and power controlled based on the communication requirements for each of those individual signals. Nonetheless, the aggregate or combined power of the communication signals typically varies over time.

For example, transmitter 10 may comprise part of a radio base station in a wireless communication network and, as such, the communication signals may include various overhead channel signals and one or more dedicated traffic channel signals intended for individual mobile stations. In that context, the transmit power allocated to individual ones of the communication signals would vary based on the signal requirements of the individual mobile stations and the prevailing radio conditions.

It should be noted that other control circuits (not shown) typically are responsible for managing the relatively fast power control applied to such communication signals. In other words, in at least one exemplary embodiment, power control circuit 12 does not manage the fast power control applied to mobile station communication signals, but rather manages null signal power such that a combination of the combined transmitted communication signal power and the transmitted null signal power remains substantially at a target power level. However, power control circuit 12 may be in communication, directly or otherwise, with fast power control circuits. In other embodiments, power control circuit 12 may be integrated with, or otherwise include the fast power control circuits and, possibly, other control elements.

FIG. 2 offers an illustration of such control functionality. Here, control circuit 12 monitors, or is otherwise apprised of, the time-average combined communication signal power being transmitted, and allocates to one or more null signals whatever amount of transmit power is required to maintain the overall (total) transmit power of transmitter 10 substantially at a constant power level. Control circuit 12 may operate with a defined target power level which may be at or below a maximum transmit power of transmitter 10, and will thus transmit one or more null signals as needed at whatever transmit power is needed such that the combination of null and communication signal powers substantially equals the target power level.

As defined herein, the term “null signal” denotes literally any signal not intended for use by any receiving station. In other words, a null signal is a signal transmitted for the sake of adjusting the total transmit power of transmitter 10 rather than for serving any communication purpose. While the present invention does not restrict the manner in which such null signals are formulated, it does contemplate several exemplary formats. As a first example, null signals may be transmitted using unassigned channelization codes, e.g., unassigned Walsh codes. Thus, an exemplary null signal simply is a transmit signal encoded with a spreading code not currently assigned to any receiving station such that the signal does not interfere with or confuse intended signal receptions at any active receiving station. Generating null signals in this manner has the advantage of conforming to the same transmit signal generation function as used for the actual communication signals, which simplifies null signal transmission.

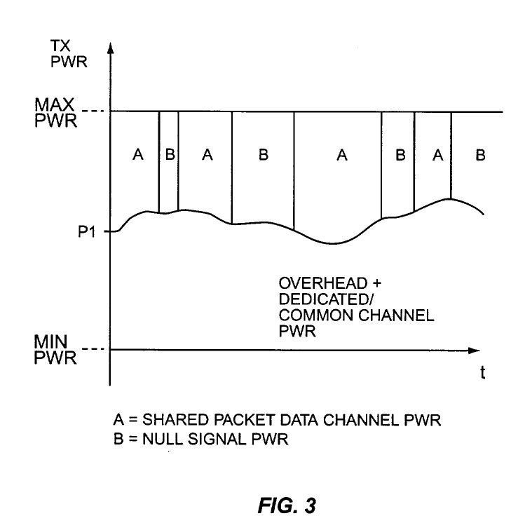

Similarly, as illustrated in FIG. 3, the null signal may be a null shared packet data channel signal as might be used in an IS-2000 or WCDMA network, for example. With that configuration, transmitter 10 transmits overhead, common, and dedicated communication signals as needed at a first combined transmit power, and transmits one or more forward shared packet data channel signals as needed at whatever power remains available at transmitter 10. That is, the forward packet data channel signals typically are transmitted using whatever leftover power remains available at transmitter 10.

However, because such shared channel signals typically are active only when data is available for transmission to one or more mobile stations (users) sharing the channel, absent operation of the present invention, transmitter 10 essentially would turn the shared signal on and off depending on data availability. Such on and off operation of the shared signal causes potentially significant and rapid changes in the total transmit power of transmitter 10. With operation of the present invention, the off times for the shared channel are filled with a null shared channel signal.

FIG. 3 illustrates such operation by showing alternating “A” and “B” transmissions of the shared channel signal. During times “A”, the shared signal carries data for one or more users of the shared channel, and at times “B”, transmitter 10 simply transmits the shared channel signal as a null data signal.

As with the use of unassigned Walsh codes described earlier, the shared channel signal may be configured as a null signal simply by transmitting, for example, null (zero) data to a fictitious user (e.g., to an unassigned Medium Access Channel (MAC) ID), or by otherwise configuring the channel such that it does not carry data for any receiving station currently sharing the channel.

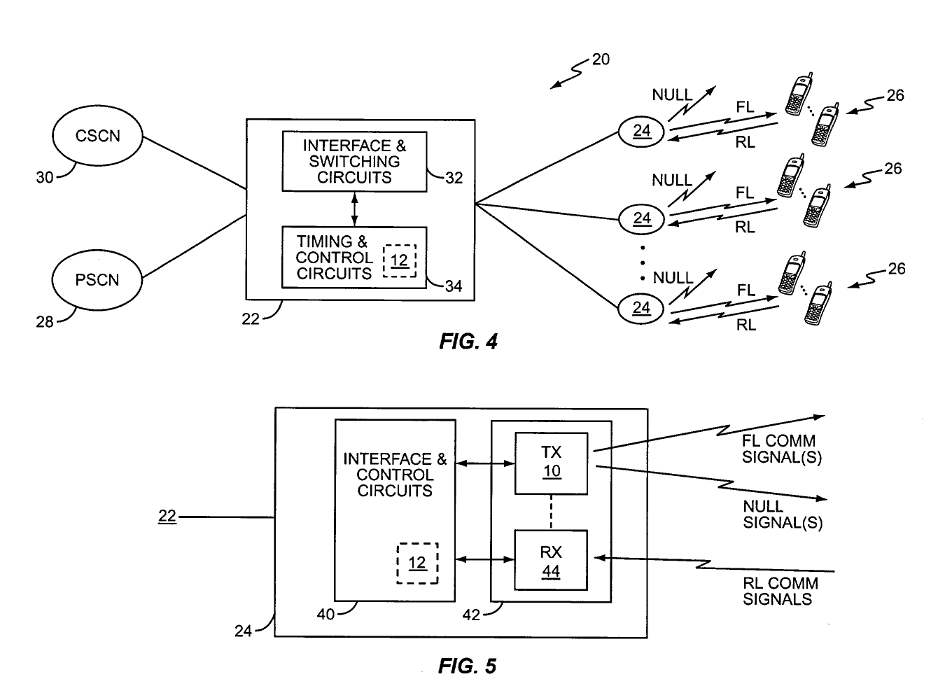

FIG. 4 illustrates an exemplary wireless communication network 20, which comprises a Base Station Controller (BSC) 22 that controls a plurality of Radio Base Stations (RBSs) 24. In operation, BSC 22 communicatively couples pluralities of mobile stations 26 to a Packet Switched Core Network (PSCN) 28 or to a Circuit Switched Core Network (CSCN) 30, which in turn are coupled to one or more external networks such as the PSTN and the Internet. Note that each RBS 24 transmits forward link communication signals supporting mobile station communications, and receives reverse link signals from the mobile stations 26 and, additionally, each RBS 24 transmits one or more null communication signals as needed to reduce transmit power fluctuations at the RBS 24. Indeed, it should be noted that the RBSs themselves may include sectorized transmitters, wherein the present invention operates to reduce total transmit power fluctuations on a per sector basis.

As shown, an exemplary BSC 22 comprises interface and switching circuits 32 and timing and control circuits 34. In accordance with one embodiment of the present invention, one or more power control circuits 12 reside in BSC 22.

With the illustrated embodiment, fast power control of the communication signals transmitted from each RBS 24 may be controlled at the RBS level, while management of the total transmit power from each RBS 24 for purposes of reducing total transmit power fluctuations may be managed at the BSC level. With this configuration, the rate at which power control circuit 12 adjusts the total transmit power from each RBS 24 by manipulation of the null signal power transmitted from that RBS may be set to avoid undue BSC-to-RBS signaling while maintaining a rate of control that yields acceptable fluctuation reductions in RBS transmit power.

FIG. 5 illustrates an exemplary RBS 24, which comprises interface and control circuits 40 and transceiver circuits 42, which include transmitter 10 and receiver 44. Again, as was noted earlier, transmitter 10 may comprise multiple, individually controllable transmitter circuits and, likewise, receiver 44 may comprise a plurality of individually controllable receiver circuits. Regardless, FIG. 5 illustrates that power control circuit 12 may be implemented at the RBS level by including it, for example, within the RBSs interface and control circuits 40. On this point, it should be understood by those skilled in the art that power control circuit 12 may or may not comprise a separately implemented circuit.

For example, in one or more exemplary embodiment power control circuit 12 is implemented as a programmed function in one or more processor circuits residing within BSC 22 or within RBS 24. Thus, power control circuit 12 may comprise a digital logic circuit configured according to stored program instructions residing at the BSC or RBS level. Indeed, those skilled in the art will recognize that the location of power control functionality in accordance with the present invention is not critical to practicing the present invention.

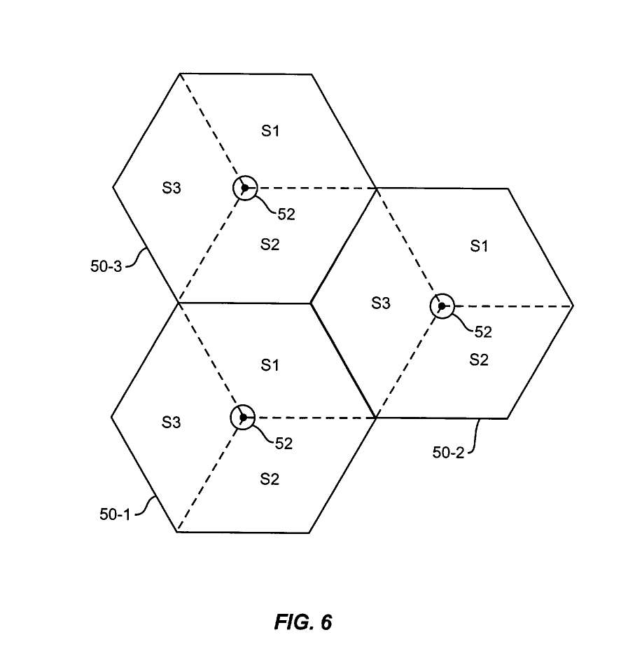

While the present invention offers many advantages, FIG. 6 illustrates an exemplary framework for discussing one of its particular advantages. The illustration depicts sectorized cells 50-1 through 50-3, with each cell 50 including sectors S1 through S3. Supporting this sectorized configuration, each cell 50 includes a sectorized base station 52, which supports communication with mobile stations 26 within each sector. Thus, each base station 52 may include sectorized transmitter circuits 10, and one or more power control circuits 12 that are operated to reduce fluctuations in the total transmitted power for each sector.

Reducing sector power fluctuations reduces variation in both inner-cell and outer-cell interference. As those skilled in the art understand, inner-cell interference denotes interference between the communication signals transmitted from mobile stations 26 within the same sector, while the term outer cell interference denotes the interference in a given sector caused by transmissions in neighboring sectors.

As noted earlier, interference fluctuations affect not only fast power control of dedicated channels but also rate control of any shared data channels. Interference fluctuations affect the performance of the scheduling and rate control because each mobile station must measure and report its FL channel quality (using the pilot of its serving sector) back to the sector.

The channel quality information is used by the sector for scheduling the mobile stations and for assigning the data rate (modulation, coding rate, # of slots . . . ) i.e. rate control. Rapidly changing interference increases the likelihood that actual channel quality may change significantly between the time a mobile station transmits a channel quality report to the network and the time when the network serves the mobile station at a data rate based on that reported channel quality. Thus, when channel quality is reported less accurately by the mobile stations, the sector may not schedule the “optimum” mobile station or it may assign a non-optimum rate for the scheduled mobile station. In the end, this can reduce sector throughput.

Similar inaccuracies in fast power control arise from rapid changes in the prevailing interference experienced by mobile stations 26. In other words, reliable forward link power control depends on the mobile station reporting its received signal quality to base station 52, or depends on the mobile station commanding base station 52 to increase or decrease the power allocated for transmissions to that mobile station based on received signal quality.

Again, because of the lag between the mobile station's observations regarding the received signal quality and the resultant reported command transmission back to base station 52, rapid changes in the prevailing interference at the mobile station can compromise the accuracy of such forward link power control. Therefore, reducing base station transmit power fluctuation reduces fluctuations in interference at the mobile stations and thereby reduces forward link power control inaccuracies.

Such operation may be particularly beneficial in communication networks employing shared packet data channels because such channels typically are data rate controlled rather than power controlled. That is, a mobile station that receives data on a shared packet data channel signal typically provides a carrier-to-interference (C/I) ratio or other signal quality measurement to the base station 52 providing the shared packet data channel signal. That supporting base station 52 uses the reported value to determine the appropriate data rate for the mobile station. That is, the base station 52 generally transmits data at the highest rate appropriate for the reported reception quality value. Thus, if the reception quality at the mobile station suddenly changes between the last report and the subsequent transmission from base station 52, the mobile station will likely receive data at a higher rate than is appropriate for the changed reception conditions. Therefore, by practicing the present invention the likelihood that any given mobile station will experience such a rapid change in reception conditions is substantially reduced.

Of course, the present invention offers other advantages as will be appreciated by those skilled in the art. For example, operating base station transmitters at substantially constant powers over given time intervals may simplify their design by lessening the need to rapidly change transmit powers. Further, operating base station transmitters at substantially constant total transmit powers may relieve component stress associated with rapidly increasing or decreasing transmitter power.

Those skilled in the art will recognize that the present invention offers other advantages and features. Additionally, it should be understood that the foregoing discussion is exemplary rather than limiting. Indeed, the present invention is limited only by the following claims and their reasonable equivalents.

What is claimed is:

1. A method of controlling a total transmit power in a transmitter comprising:
transmitting communication signals as needed from the transmitter to support communication with one or more mobile stations; and
transmitting one or more null signals as needed from the transmitter to reduce fluctuations in a total transmit power of the transmitter.

2. The method of claim 1 further comprising:
defining a target level for the total transmit power; and
setting a null signal transmit power based on an amount by which a communication signal transmit power falls short of the target level.

3. The method of claim 2, further comprising varying the communication signal transmit power over time as needed and inversely varying the null signal transmit power to maintain the total transmit power of the transmitter station substantially at the target level.

4. The method of claim 2, further comprising determining the null and communication signal powers as time average power values.

5. The method of claim 2, further comprising setting the null signal transmit power at substantially zero if the communication signal transmit power is at or above the target level.

6. The method of claim 1, wherein transmitting communication signals as needed includes transmitting user data on a shared packet data channel signal if such user data is available, and wherein transmitting one or more null signals as needed comprises transmitting null data on the shared packet data channel signal if no user data is available.

7. The method of claim 6, wherein transmitting user data on the shared packet data channel signal comprises transmitting to assigned mobile station identifiers, and wherein transmitting null data on the shared packet data channel signal comprises transmitting to one or more unassigned mobile station identifiers.

8. The method of claim 1, wherein transmitting one or more null signals as needed comprises transmitting signals using one or more unassigned channelization codes.

9. The method of claim 8, wherein transmitting one or more unassigned channelization codes comprises transmitting signals using one or more unassigned Walsh codes.

10. A wireless network node for use in a wireless communication network comprising:
one or more radio frequency (RF) transmitter circuits; and
one or more control circuits to transmit communication signals as needed from the transmitter circuits to support communication with one or more mobile stations and to transmit one or more null signals as needed from the transmitter circuits to reduce fluctuations in a total transmit power of the node.

11. The node of claim 10, wherein the one or more control circuits determine a target level for the total transmit power of the node and set a null signal transmit power based on an amount by which a communication signal transmit power falls short of the target level.

12. The node of claim 11, wherein the one or more control circuits vary the communication signal transmit power over time as needed and inversely vary the null signal transmit power over time to maintain the total transmit power of the node substantially at the target level.

13. The node of claim 11, wherein the one or more control circuits determine the null and communication signal powers as time average power values.

14. The node of claim 11, wherein the one or more control circuits set the null signal transmit power at substantially zero if the communication signal transmit power is at or above the target level.

15. The node of claim 10, wherein the one or more communication signals comprise a shared packet data channel signal on which user data is transmitted to one or more mobile station as needed, and wherein the one or more null signals comprises the shared packet data channel on which null data is transmitted if there is no user data to be transmitted.

16. The node of claim 15, wherein the node transmits user data on the shared packet data channel signal by transmitting data to one or more assigned mobile station identifiers, and wherein node transmits null data on the shared packet data channel signal by transmitting to one or more unassigned mobile station identifiers.

17. The node of claim 10, wherein the node transmits the one or more null signals by transmitting signals using one or more unassigned spreading codes.

18. The node of claim 17, wherein the node transmits on one or more unassigned spreading codes by transmitting signals using an unassigned Walsh code.

19. The node of claim 10, wherein the node includes an IS-2000 base station in an IS-2000 wireless communication network, and wherein the base station transmits one or more communication signals by transmitting a Forward Packet Data Channel (F-PDCH) signal carrying user data to one or more mobile stations, and wherein the base station transmits one or more null signals by transmitting the same F-PDCH signal but carrying null data.

20. The node of claim 10, wherein the node includes a WCDMA base station in a WCDM wireless network, and wherein the base station transmits one or more communication signals by transmitting a High Speed Packet Data Access (HSPDA) channel signal carrying user data to one or more mobile stations, and wherein the base station transmits one or more null signals by transmitting the same HSPDA channel signal but carrying null data.

21. A method of controlling a total transmit power in a transmitter comprising:
transmitting communication signals as needed from the transmitter to support communication with one or more mobile stations, said communication signals having a varying communication signal power;
transmitting one or more null signals as needed from the transmitter to reduce fluctuations in a total transmit power of the transmitter, said null signals having a varying null signal power;
defining a target level for a total transmit power of the transmitter, the total transmit power being defined as the communication signal power and the null signal power; and
varying the communication signal power as needed to support mobile station communication, and inversely varying the null signal power to maintain the total transmit power substantially at the target level.

22. The method of claim 21, wherein the one or more communication signals include overhead channel signals and dedicated traffic channel signals, and wherein varying the communication signal power as needed to support mobile station communication comprises varying individual ones of the dedicated traffic channel signals responsive to power control commands from corresponding mobile stations.

23. A method of controlling a total transmit power in a transmitter comprising:
transmitting a shared packet data channel signal on a continuous basis;
including user data in the shared packet data channel signal if user data is available for any of one or more mobile stations sharing the shared packet data channel signal; and
including null data in the shared packet data channel signal if no user data is available.
